(19) United States
(12) Patent Application Publication
(10) Pub. No.: US 2002/0116472 A1
(43) Pub. Date: Aug. 22, 2002

(54) Method and system for pushing content through cellular network

(75) Inventors: Dan Kalish, Rannana (IL); Yaron Kalish, Haifa (IL)

Correspondence Address: SHAHAN ISLAM, ESQ., ROSENMAN & COLIN LLP, 575 Madison Avenue, New York, NY, 10022-2585, US

(73) Assignee: Niragonogo Inc., Herzelia (IR)

(21) Appl. No.: 09/790,006

(22) Filed: Feb. 20, 2001

(51) Int. Cl. G06F 15/16

(52) U.S. Cl. 709/218; 709/203

(57) ABSTRACT

The present invention provide method and system of pushing data objects during communication session integrated within networking system of plural client agents connected via gateway server.

The present invention takes advantage of the existing open communication session for pushing data objects to the user by intercepting users communication, identifying open connections and replacing received response original content with new content including any given data object. As a result the user is provided with the edited response, the user can optionally request the response with the original content. For optimizing the communication process it is suggested to present the user with the pushed data object during idle periods while the user is waiting for next content.

### BACKGROUND OF THE INVENTION

The present invention relates to wireless networks push technologies. More specifically, the invention relates to methodologies and utilities for providing mobile users with notifications, messages and multiple session activity through wireless networks.

Push technology enable information providers to distributes information that constantly or periodically changes, such as stock market quotes, to clients via computer networks.

Traditionally push services provided by companies like PointCast, suggest the following scenario: information is collected from diverse sites on the Internet and is made available to clients in distinct, categorized, channels. Clients pre-subscribe to those channels are provided with information, available to the client's browser by simply selecting the categories, or “channels”. Hence, the term “push” is used, as contrasted to the term “pull”, where the client pulls information from various different source sites after browsing the Internet and selecting the sources one by one. To the client, this arrangement appears more like cable TV, where premium channels are subscribed to and, once subscribed to, are always available to the client.

Push technology is used extensively in satellite, cable, and conventional radio applications, where information is broadcast to all clients who are passive listeners Adopting a true push approach would clearly overcome the server overload problem and the routing overhead problem. However, it would introduce other problems. For example, requiring the browsers of client devices such as cellular phones to accept information whenever some transmitting point chooses to push information. This requires major modifications to the browsers and client devices that are currently available.

Today IP cellular technologies enable to transmit content to mobile users in response to users request for specific network page or filtered date in response to user selections and preferences. Content providers who wish to distribute their messages using IP technologies have to assist the IP service providers, exiting portals or notification services.

Push technology is well known in the Internet world. In wireless Internet, and in WAP in practically (WML 1.1), there is no support of providing push services to subscribers. Push services can enrich the subscriber experience by enabling notifications services (for example, email notification).

Today wireless push technologies are either initiating new session connections before transmitting the designated content to the user or assume that the user is constantly connected to the wireless network (Which is true only for future cellular network e.g. GPRS). Such technologies demand to adapt the mobile devices for implementing the push protocol. Further more, there is no way to ensure the user is available for receiving the pushed content.

Another point to consider when examining push technology is the tremendous amounts of space occupied, and delay of data flow between the users and network.

It is thus the prime object of the invention to provide a method and system for enabling push capabilities for wireless phone devices and various other constrained devices

It is thus a further object of the invention to provide navigation utilities enabling parallel session through a wireless network when using various constrained navigation devices.

It is a further object of the invention to provide a method of accelerating the delivery of content to the user of such network.

### SUMMARY OF THE INVENTION

A method of pushing data objects during communication session of hyper text language based pages (“network page”) integrated within networking system of plural client agents connected via gateway server, said method comprising the steps of intercepting users communication via network at the gateway server; identifying open connections and associating intercepted communication request to users receiving request for network page from the user agent; forwarding user request for downloading network page from source server to network system; receiving respective response from network to user requests; replacing received response original content with new content including any given message; transmitting the edited response to user agent; and upon user selection, transmitting the received response with the original content to user agent.

### BRIEF DESCRIPTION OF THE DRAWINGS

These and further features and advantages of the invention will become more clearly understood in the light of the ensuing description of a few preferred embodiments thereof, given by way of example only, with reference to the accompanying drawings, wherein—

FIG. 1 is a general diagrammatic representation of the environment in which the present invention is practiced;

FIG. 2 is a flow-chart of transmitting messages during session according to the present invention;

FIG. 3 is a flow-chart of user navigation using parallel session according to the present invention;

FIG. 4 is a flow-chart of transmitting content “while waiting” according to the present invention;

FIG. 5 is a flow chart of transmitting content during planned session according to the present invention;

FIG. 6 is an editing-message process according to the present invention;

### DETAILED DESCRIPTION OF THE PREFERRED EMBODIMENTS

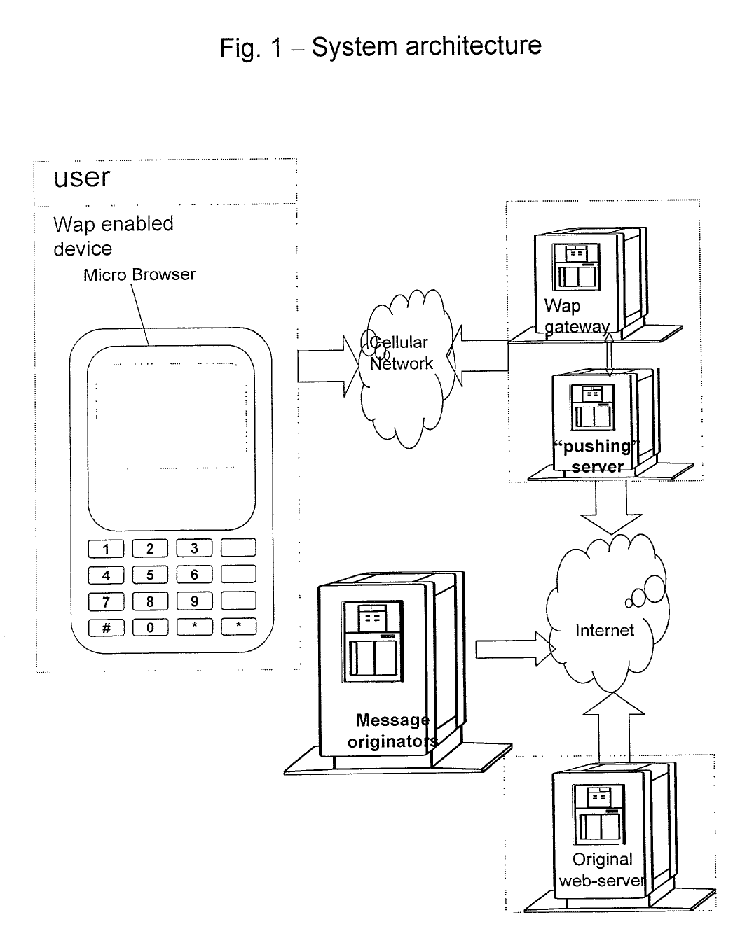

FIG. 1 illustrates one possible network configuration, in which the present invention can be implemented.

Referring to FIG. 1 of the drawings, it will be seen that a user A is connected through cellular network P to the gateway server in connection to designed server C (hereinafter called “The pushing server”), this server serves as an intermediator server between the user mobile device (hereinafter called “the user agent”) and the Internet web servers containing data available for user access (hereinafter called “the original server”). One type of original servers may include messages originator such as e-mail service (e.g. Hotmail).

Let us assume that the user A has placed a request for a hypertext based data file (hereinafter called the “network page”), (a common standard for cellular networks is a WML page).

According to the prior art routine, when a user places a request for a WML page through wireless network, after receiving the respective response, the gateway server forward the request to the Internet backbone for downloading the requested network page Upon receiving the respective request the gateway server transmits thereof to the user agent. This procedure of communicating between the user agent and the Internet is known as communication session.

Taking into consideration that a certain time lag is involved in downloading each WML page it will be appreciated that this process is often cumbersome and time consuming.

The main concept of the present invention is to take advantage of the existing communication session process for pushing data objects to the user. Prior art push technologies initiates new dedicated connections before transmitting the designated content to the user. Such processes demand to adapt the mobile devices for implementing the push protocol. Further more, as these are out-of-session transmissions, the user may be in session, hence there is no way to ensure the user is available for receiving the pushed content. The implementation of such intrusive messages is highly user-agent dependant.

Accordingly, it is herein proposed that before transmitting the respective response to a user request through the wireless network, the respective response is modified or merged to include designated data objects.

There are several possible ways for implementing the services described below depending on the specific markup language in use, on the data transfer protocol, and on the capabilities of the said navigational device. For the sake of clarity we shall detail one such possible implementation, wherein WML is the markup language. WAP is the transfer protocol used for data transfer and WAP enabled mobile phone as navigational device in which the programming and storage capabilities are constrained (such that the management of the navigation process is best handled on the server.)

Four possible services are proposed according to the present invention, the first one enables to merge any given now message or notification of such a message.

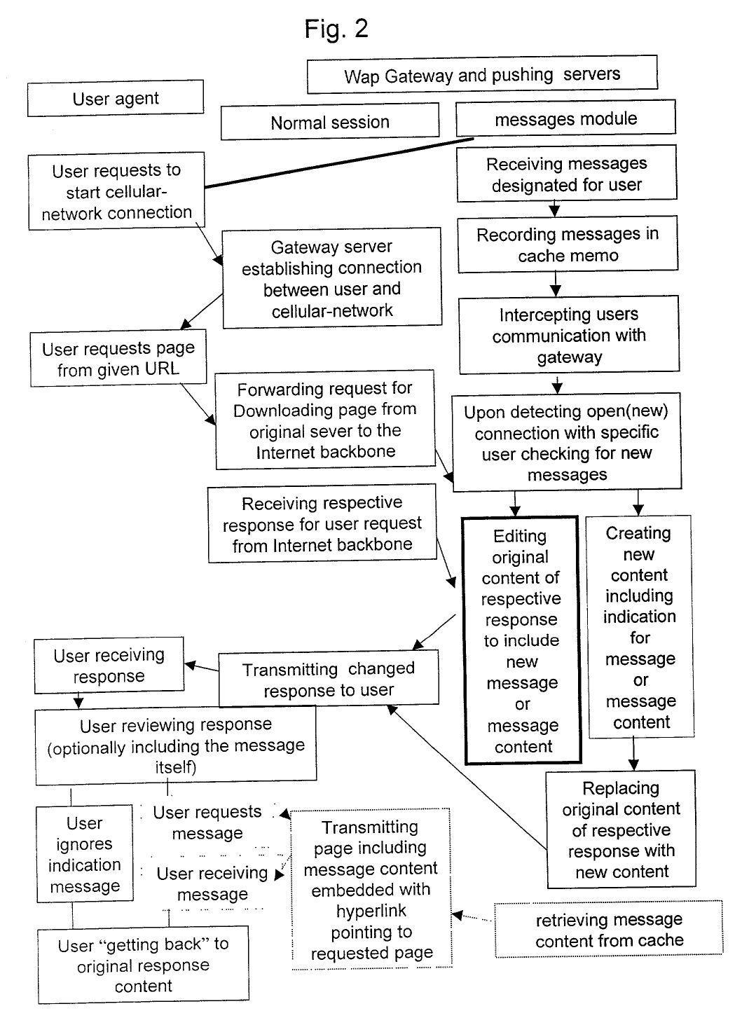

FIG. 2 illustrates the process of transmitting messages during normal communication session: the client establishes connection with the gateway server and requests any given network page. The pushing server intercepts all open connections and identifies respective users. According to the first service option the pushing server includes a messages module for managing all incoming messages addressed to users agents. The messages module receive all incoming messages and records them in cache memory. The module monitors all open user-agent connections and detects user requests for new content associated with said targeted users. Upon detecting such new content requests the pushing server intercepts the respective response for user requests. Then, the messages module replaces the content of the received response with new content including the pushed message. According to the present invention there are two main options at this stage of the process. According to the first option the new content includes the new message itself or an indication (link) to the new message. As a result the user first receives not the originally requested network page, but the new content. Once reviewing the pushed message or indication thereof the user can receive the original response content including the downloaded page.

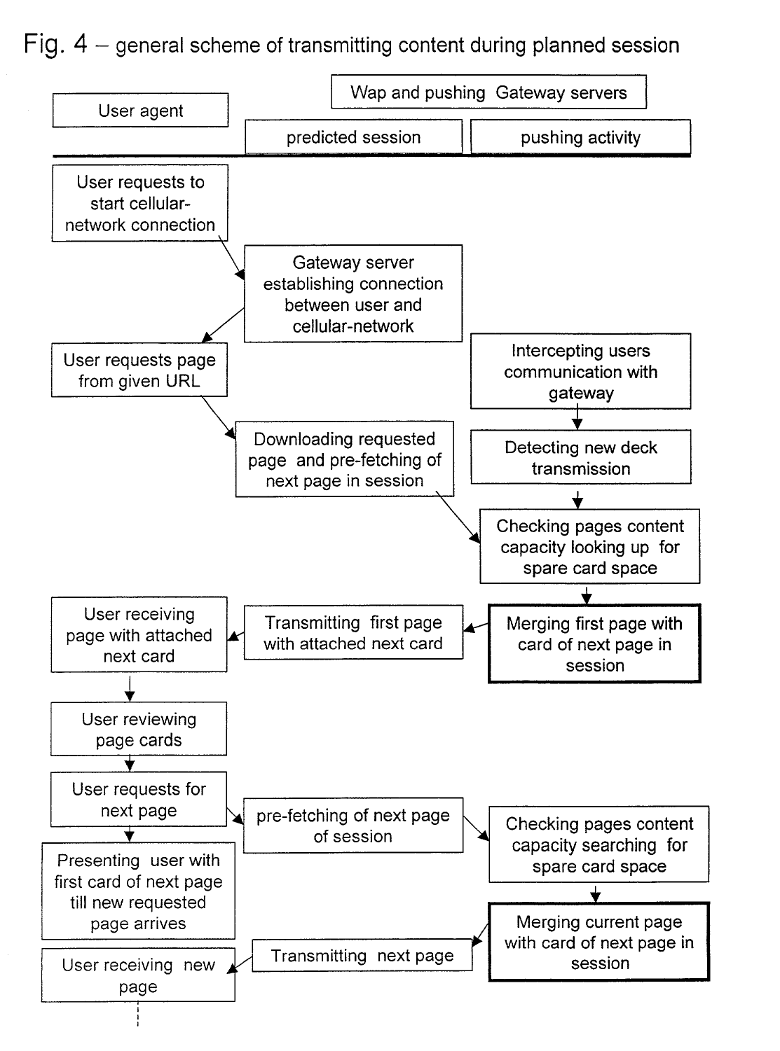

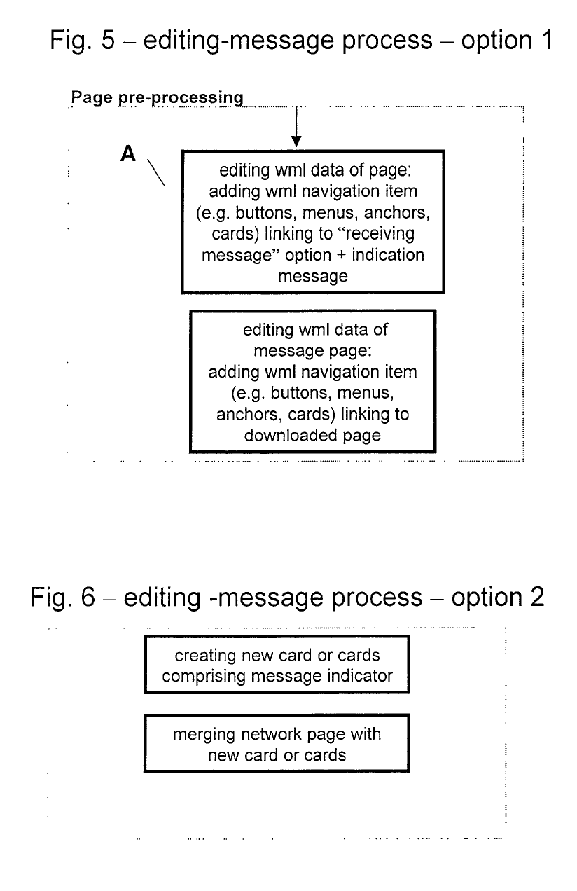

According to a second alternative the new content includes edited version of the original content page. The editing process can be implemented either by adding hyperlinks and adding text or visual objects to the page code as illustrated in FIG. 5 or alternatively by merging new card or cards as illustrated in FIG. 6. The edited version of the network page may include the message itself if it is small enough to fit into available cards space or just an indication of the message including new hyperlink linking to cache location of message. Additionally, the message code may be edited to include now hyperlink linking to cache location of the original requested content page enabling the user to return to the requested network page.

The editing process can take place at the navigation server or alternatively at the cellular device, depending on the cellular device processing-power and memory limitations.

The pushing server retrieves the message form the cache memory and transfers the message including the added hyperlink as response to the user agent request. After viewing the message, the user can select the added hyperlink for returning to the original requested content page.

The second service suggested by the present invention is parallel session navigation mode as illustrated in FIG. 2.1. According to prior art push technologies, once the user is provided with new message he is cut off from the current navigation session, the user may start a new navigation session starting from the received message, but is unable to return to the first navigation session before the message arrived. The procedure according to the second service enables the user to keep one click “back to session” navigation option along the new session navigation, As seen in FIG. 2.1 flow each new network page of the navigation session is edited to include new hyperlink “back to session” option referencing to the last downloaded network page before the message arrived. Maintaining the option to return to the first session along the entire new navigation session is an important feature.

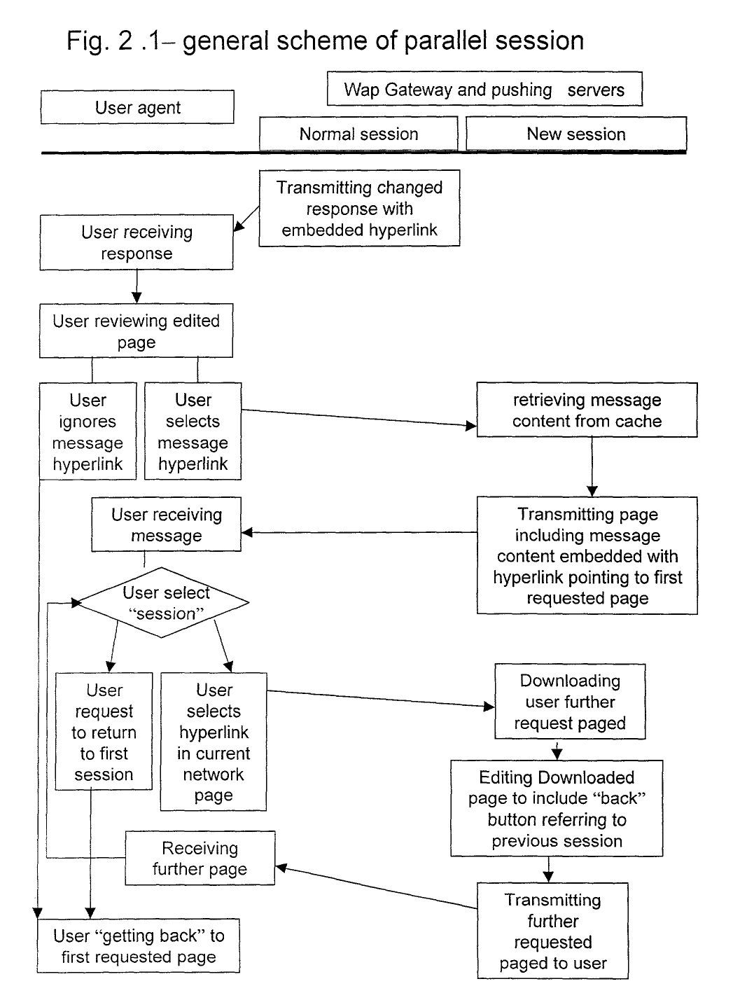

The third service suggested according to the present invention as illustrate in FIG. 3 enables pushing content during idle periods while the user is waiting for the next page to be downloaded. According to prior art technologies the cellular network sessions include idle periods for the user, while the user is waiting for the next network page. The pushing module according to the present invention intercepts all communication sessions of user agents with the gateway server. All incoming downloaded page are examined, checking the network page capacity to detect spare cards space. Upon detecting such card space the pushing module merges the network page with new created card, which may include any desirable content. The merging process comprise the step of editing the detected network page for replacing all hyperlinks references to new card internal location, the original references are temporarily recorded in cache memory.

Once the user reviewed the original network page cards and selects any of the available hyperlinks, the user is first directed to the new card, While the user views said card the user agent requests the next network page according to the selected hyperlink. The new card is presented till the next network page arrives to the user agent.

According to further improvement of the third service it is suggested to include in the new created deck, content which is related to the context of the downloaded network page. For example, the new card may comprise advertisements relating the context of the downloaded page. Further more, as the pushing module can identify user gateway location the new deck content may be related to user geographical location zone.

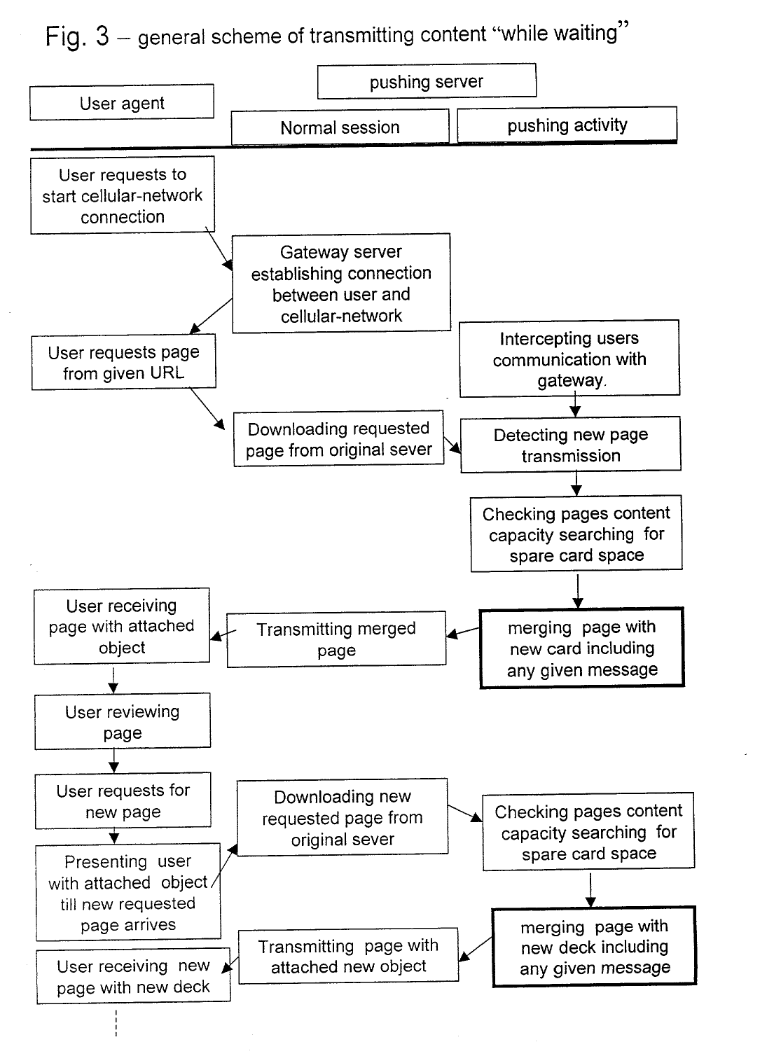

The fourth service suggested according to the present invention is optimization of predicted navigation sessions as illustrated in FIG. 4. The process concept is similar to the previous pushing “while waiting” process as described above. The pushing module intercepts all user communications data for detecting spare cards space in downloaded pages. When conducting prediction navigation session the “prediction” server (which can be associated with the gateway server or the pushing server). requests to download network pages not only according to user request but additionally pre-fetch network page or pages according to any given prediction modules. There are known various methods for predicting user next request e.g. by tracing users behavior patterns. Provided with prediction results the pushing server can merge the current downloaded page with the first card of the prefetched network page. In case the user actually selects the pre-fetched network page, he is presented with the first card of the next network page while waiting for the next network page to reach his mobile device from the “prediction” server.

The implementation of the said service process is similar to the previous service, only the first network page is merged not with any content but with a specific card of the next predicted page to be downloaded.

This integration process, as illustrated in FIG. 15, is applied according to the memory limitation of user agent, the number of integrated pages is constrained by the memory capabilities of the user agent.

The advantages of the above described process are clear. If the user requests the predicted net work page, its content already exists in user-agent memory, the time lag of transferring the network page from the prediction server to the user agent is spared.

Prediction session can emerge also from pre-planned sessions, i.e. preset sequences of hypermedia sources. However, although being pre-set at the actual time of navigation, these sequences need not be determined until such time as they are to be used Such preset sequences can originate from various sources:

1. Man-made sequence: This sequence may be prepared on a general-purpose computer using traditional navigation utilities (e.g. Web Browser Software). Alternatively the sequence may be entered from the constrained device either by way of keying in each nodes date or by way of a provision amongst the navigational aids for selecting designated or current URL as a node in the sequence. For example such a track of hypermedia links might be the persons personal information services e.g. stocks, local weather, etc.

2. Mechanically produced on demand resource locators (on demand track): A group of resource locators may be provided in form of a hypermedia source, or in any other computerized media and format accessible to the navigation server at the time of track creation. For clarity, take the example of location-based services for mobile users. For instance a person roaming the streets with a mobile hand set might want to view a sequence of upscale restaurants in his vicinity. Given a computerized service capable of providing the raw data comprising required restaurants, for instance by way of database query provided users location and required class of restaurants, a navigational trail may be created on the fly from said query result.

3. Search results: In this case the required collection of hypermedia links may be extracted from the hypermedia source that is the final output of the search engine, or from any intermediate interior representation of said collection of links, such as a database query result.

4. Any network information source: transformed, for or by the navigation server, into the hypermedia format appropriate for the user agent. An example of such implementation might be a users email inbox, from which each individual email can be accessed, if necessary translated into appropriate hypermedia representation, and linked together with all the other emails to form a trail. Thus enabling the user to browse conveniently and in an accelerated manner through his/her pending mail.

Finally, it should be appreciated that the above-described embodiments are directed at a cellular communication environment. However, the invention in its broad aspect is equally applicable to computerized network communication in general, such as satellite, blue-tooth, and others.

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiments illustrated but by the appended claims and their legal equivalents.

What is claimed is:

1. A method of pushing data objects during communication session of hypertext language based pages (“network page”) integrated within networking system of plural client agents connected via gateway server, said method comprising the steps of:
(i) Intercepting users communication via network at the gateway server;
(ii) Identifying open connections and associating intercepted communication request to users;
(iii) Identifying request for network page from the user agent;
(iv) Forwarding user request for network page from source server to network system for which the request was intended;
(v) Receiving respective response from network system to user request;
(vi) Replacing original content received response with new content including any given message;
(vii) Transmitting the edited response to user agent; and
(viii) Upon user selection, transmitting the originally received response, with the original content, to user agent;

2. The method according to claim 1 wherein the new content includes edit version of the downloaded page;

3. The method according to claim 2 further comprising the step of,
(ix) Editing the downloaded page code using at least one of the following operations, adding hyperlinks with reference to any given URL, exchanging URL reference of exiting hyperlinks, adding any given hypertext command or textual or visual content;

4. The method according to claim 3 further comprising the steps of:
(x) Checking for incoming new messages for the user;
(xi) Editing network page to include indication of incoming new message and hyperlink to new massage;
(xii) Editing message page code to include hyperlink to the originally downloaded page;

5. The method according to claim 4 further comprising the steps of:
(xiii) in case the user selects any hyperlink from the message page, editing new downloaded response network page to include hyperlink to originally downloaded page;
(xiv) In case the user selects added hyperlink referencing the original downloaded page transmitting user said page from cache memory;

6. The method according to claim 5 wherein the processing steps (xiii) and (xiv) are applied to the next web page selected by the user.

7. The method according to claim 1 further comprise the step of:
(xv) Checking downloaded network page capacity for spare card space with respect to user agent and data communication capabilities;
(xvi) In case of spare card space, editing said network page to include at least one implanted new card containing any given content and exchanging URL reference of at least line hyperlinks to URL of said card;
(xvii) Upon user selection of said edited hyperlink, presenting to the user new implanted card or cards, and simultaneously requesting the page that the originally replaced URL had referenced;
(xvii) Displaying the implanted card to the user until the user agent receives the network page downloaded from original URL reference of selected hyperlink;

8. The method according to claim 7 further comprise the steps of:
(xix) Pre-fetching at least one network page according to hyperlinks URL reference of downloaded page;
(xx) Extracting one card or some partial amount of content from each pre-fetched network page;
(xxi) Editing the downloaded page to include at least one extracted card or some partial content of pre-fetched network page;
(xxii) In case user selected hyperlinks which their respective network page was pre-fetched then presenting user respective card or cards or partial content locally at the user agent;

9. The method according to claim B further comprising the steps of:
(xxiii) As the user browses the added content, fetching the rest of the original content of the respective network page, by the user agent;
(xxiv) When the user requests to see further information from said partial intent, displaying to the user the content downloaded during step (xxiii);

10. A system of pushing data objects during communication session of hyper text language based pages (“network page”) integrated within networking system of plural client agents connected via gateway server, said system comprising of:
(xxv) Communication means for intercepting users connections with network at the gateway server;
(xxvi) Detecting means for identifying open connections and associating intercepted communication requests to users;
(xxvii) Communication procedure for identifying request for network page from the user agent and forwarding user request to network system;
(xxviii) Communication means for receiving respective response from network to user requests;
(xxix) Editing means for replacing original content of received response with new content including any given data object;
(xxx) Managing means for transmitting either the edited response or the received original response according to user selection;

11. The system according to claim 10 wherein the new content includes edited version of the downloaded page;

12. The system according to claim 10 further comprising:
(xxxi) Editing means for performing at least one of the following operations to the downloaded page code: adding hyperlinks with reference to any given URL, exchanging URL reference of exiting hyperlinks, adding any given hypertext command or textual or visual content;

13. The system according to claim 12 further comprising the steps of:
(xxxii) Managing means for checking and organizing incoming new messages for the user;
(xxxiii) Editing means for adding to network page new indication of incoming messages and hyperlinks to said massages;
(xxiv) Editing means for adding message page code an hyperlink to the downloaded page;

14. The system according to claim 13 further comprising of,
(xxxv) Editing means for adding the new downloaded network page hyperlink directing to the original downloaded page according to user selection;
(xxxvi) Managing means for transmitting the original downloaded page from cache memory according to user selections;

15. The system according to claim 10 further comprising of:
(xxxvii) Testing means for checking downloaded network page capacity for spare card space with respect to user agent and data communication capabilities.
(xxxviii) Editing means for adding said network page to include at least one new implanted card containing any given content and exchanging URL reference of at least one hyperlinks to URL of said card;
(xxxix) Synchronizing procedure for presenting user respective card or cards while waiting for next network page;

16. The system according to claim 15 further comprising of:
(xl) Prediction module for pre-fetching at least one network page according to hyperlinks URL reference of downloaded page;
(xli) Editing means for extracting at least one card of each prefetched network page and adding the extracted pages to the downloaded network;
(xlii) Synchronizing procedure for presenting user respective card or cards while waiting for next network page;
